(19) United States
(12) Patent Application Publication
(10) Pub. No.: US 2011/0055532 A1
(43) Pub. Date: Mar. 3, 2011

(54) METHOD FOR CONFIGURING AN ELECTRONIC ORGANIZER

(75) Inventors: André Schiltz, Bernin (FR); Pascal Peschet, Dives-Sur-Mer (FR); Serge Hily, Bayeux (FR); Gerard Babin, Bieville Beuville (FR)

(73) Assignee: France Telecom, Paris (FR)

(21) Appl. No.: 12/862,019

(22) Filed: Aug. 24, 2010

(30) Foreign Application Priority Data
Aug. 31, 2009 (FR) 09 55917

(51) Int. Cl. G06F 9/24; G06F 17/30

(52) U.S. Cl. 713/1; 707/705; 707/E17.009

(57) ABSTRACT

This method for configuring an electronic organizer installed in an item of electronic equipment comprises: a step of obtaining, based on digital data resulting from a digitization of a representation of a code, data encoded in this code and comprising at least one item of date information associated with a content; and a step of configuring said electronic organizer in order to program, on at least one date or at at least one time defined by this item of date information, an execution of a function relating to said content.

### CROSS-REFERENCE TO RELATED PATENT APPLICATION

This application claims the benefit of French Patent Application No. 09 55917, filed on Aug. 31, 2009, in the French Institute of Industrial Property, the entire contents of which is incorporated herein by reference.

### BACKGROUND

The present invention allows the automatic configuration of an item of electronic equipment.

More precisely, various embodiments of the invention relate to a method for automatically configuring an electronic organizer installed in an item of electronic equipment.

An item of electronic equipment may be, for example, a mobile telephone, a personal assistant, or, more generally an item of communication equipment that is, for instance, portable.

Embodiments of the invention may be applied, e.g., in helping a user to comply with a dosage regimen, namely, the frequency and the doses for the taking of a medication. The company eMedicis proposes on its website (http://saraband.e-medicis.eu/corporate/php/solutions/solutions adherence.php, downloaded Aug. 24, 2010) a service for reminding a user, by telephone, messaging or electronic mail, of the times for taking medications and for medical appointments.

To benefit from this service, the user must visit a website, subscribe, create a personal profile, and enter therein the dosage regimen information in order to schedule the reminder dates and times.

Unfortunately, this service has a major drawback in that the dosage regimen information is entered by the patient himself, with a considerable risk of error, with no supervision by a pharmacist or any other qualified person.

### SUMMARY

According to a embodiment, a method is provided for configuring an electronic organizer installed in an item of electronic equipment, this method comprising:

a step of obtaining, based on digital data resulting from a digitization of a representation of a code, data encoded in said code and comprising at least one item of date information associated with a content; and
a step of configuring said electronic organizer in order to program, on at least one date or at at least one time defined by said at least one item of date information, an execution of a function relating to said content.

Correlatively, a further embodiment includes an item of electronic equipment comprising:

an electronic organizer;
means for obtaining data resulting from a digitization of a representation of a code;
means for obtaining, from said data, at least one item of date information associated with a content; and
means for programming in said electronic organizer an execution of a function relating to said content on at least one date or at least one time defined by said at least one item of date information.

In this document, the concept of “item of date information” means a date in the proper sense (day, month, year) but also a schedule, or a repetition of dates and/or schedules.

For example “every Monday at 8.15 am”, “the first Wednesday of each month” and “every other day” are “items of date information” within the meaning of the invention.

The representation of the code is for example a bar code (1D or 2D) or any other graphic code or a printable representation capable of encoding an alphanumeric code. The focus here is more particularly on a code in alphanumeric sequence form, easily able to be represented according to the representation modes that have just been cited.

The data resulting from the digitization may be in different forms depending on the sensor used to produce them: an image in the case of use of a sensor in the form of a camera or, more generally, a one- or two-dimensional digital signal resulting from the sensor scanning the representation of the code.

The function for which the execution is programmed is chosen depending on the field of application and the functional possibilities of the application using the electronic organizer. As an example of a function, it is possible to cite:
the triggering of a reminder, in the form of an automatic text message displayed, or of an automatically triggered sound message, relating to said content;
the triggering of the execution of a predefined script or program;
a recording of data, relating to said content, in the organizer or in a memory of the item of electronic equipment;
a transmittal of a message, relating to said content;
a download of data, relating to said content;
a placing in communication;
etc.

A user interface of the electronic organizer configured by the method will therefore allow a display or a setup of the function for which the execution has been programmed. A user will be able notably to verify/consult/edit the programmed functions and check the consistency of these functions with his timetable. Such an electronic organizer also enables a display of a diary presenting for the considered date and/or time, information items concerning the programmed function and/or the content and/or the data encoded into the code.

In a particular embodiment, the configuration method is used to put in place, by way of the electronic organizer, an automatic reminder system in order to help a patient to comply with a medical subscription and to respect a dosage regimen indicated by a doctor.

In this example, information for taking medication corresponding to a prescription of a doctor (typically a medication name, a quantity, and a rate at which this medication is to be taken), can be supervised by a pharmacist and entered via the latter into a computer system capable of printing out a representation of a code encoding these items of information. In this case, the code is used to encode:
on the one hand, date information corresponding to the dates and/or times for taking medication; and
on the other hand, a content comprising information for taking medication such as the medication name, the dosage regimen, indications concerning the method of absorption of the medication.

In this example, the code can then be photographed by a camera incorporated into an item of electronic equipment of the patient, the photograph then being analyzed in order to extract the code from it and to deduce from it the data for taking medication, the latter being used to automatically configure the electronic organizer of the patient.

The configuration of the organizer is preferably accompanied by the programming of a reminder for taking medication, for example by means of audible or vibrator alerts, on the dates and at the times defined by virtue of the date information extracted.

Very advantageously, the patient is not involved in entering the data which prevents any risk of error on his part.

Unlike the service proposed by the company eMedicis, the configuration of the electronic organizer takes place offline and is completely automated, except for the step of entering the bar code which is initiated by a user.

Moreover, the user can view in a user interface of his electronic organizer at the same time the appointments that he has programmed by means of this electronic organizer over a given period of time and the information for taking medication relative to this same period of time. This is particularly valuable for a good organization of this user's timetable.

If this user has, for example, to travel for these appointments, he can easily organize each day to take with him the medication to be taken while he is away. Incorporating information on taking medication into an electronic organizer is therefore particularly advantageous.

Preferably, the sensor is incorporated into the item of electronic equipment.

As a variant, the sensor forms part of another device capable of communicating the digital data produced by the digitization or the date information itself to the item of electronic equipment.

The invention has applications in any other field of activity in which it is desired to automatically configure the electronic organizer of an individual.

In a particular embodiment, the various steps of the configuration method are determined by computer program instructions, this program being suitable for being installed in the item of communicating equipment.

As a consequence, a further embodiment of the invention is a computer program, on an information medium, this second program comprising instructions suitable for the application of the steps of the configuration method according to the invention, these steps being able to be applied by an item of electronic equipment or more generally by a computer.

This program can use any programming language and be in the form of source code, object code, or intermediate code between source code and object code, such as in a partially compiled form, or in any other desirable form.

A further embodiment of the invention is an information medium that can be read by a computer, and comprising instructions of a computer program as mentioned above.

The information medium may be any entity or device capable of storing the program. For example, the medium may comprise a non-transitory storage means such as an ROM, for example a CD ROM or a microchip ROM, or else a magnetic recording means, for example a diskette (floppy disk) or a hard disk.

Moreover, the information medium may be a medium that can be transmitted such as an electrical or optical signal, which can travel via an electric or optical cable, by radio or by other means. The program may be, in particular, downloaded from a network of the Internet type.

Alternatively, the information medium can be an integrated circuit in which the program is incorporated, the circuit being suitable for executing or for being used in the execution of the method in question.

### BRIEF DESCRIPTION OF THE DRAWINGS

Other features and advantages of various embodiments of the present invention will emerge from the description made below, with reference to the appended drawings which illustrate an exemplary embodiment thereof which is entirely nonlimiting. In the figures:

FIG. 1 represents a computer system of a pharmacist;

FIG. 2 represents schematically the hardware architecture of an item of electronic equipment according to a particular embodiment of the invention; and

FIG. 3 represents, in the form of a flow chart, the main steps of a configuration method according to a particular embodiment of the invention.

### DETAILED DESCRIPTION

A description will now be given of a particular embodiment of the invention making it possible to help a patient to respect a dosage regimen during a medical treatment.

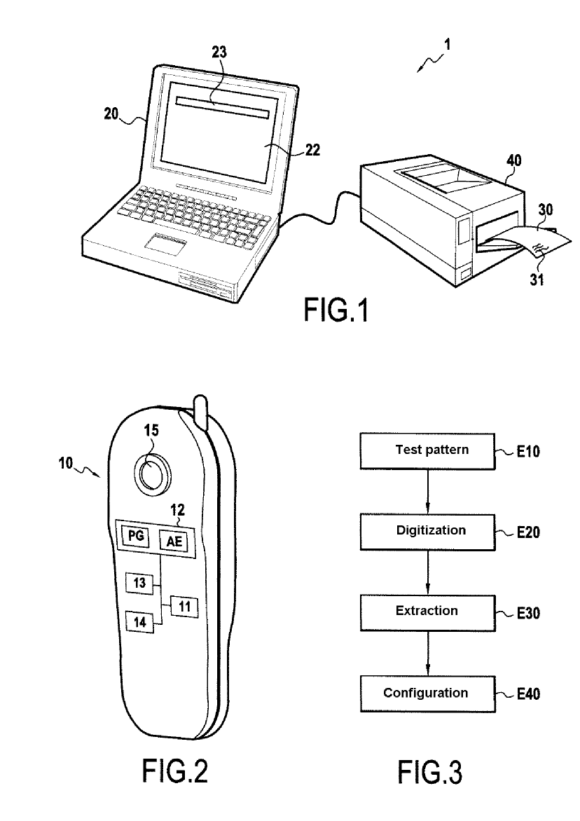

FIG. 1 represents the computer system 1 of a pharmacist, this system comprising mainly a computer 20 capable of using a software application 22 making it possible to enter information for taking medication defined in a prescription 30, and a printer 40 capable of printing out a representation of a code encoding information for taking medication. This printout can be made on the prescription itself, on the medical claim form to be sent to social security, or on any other medium from which the representation of the code is capable of being digitized by a sensor.

In the exemplary embodiment described here, the software application 22 has an input field 23 allowing the pharmacist to enter information for taking medication for one or more medications prescribed by a doctor, namely in this example:

the name of the medication;
indications on the method of absorption of the medication (with a glass of water, 15 minutes before mealtimes, etc.);
the dosage regimen or the prescribed dose; and
date information for taking the medication.

Hitherto, these data are conventionally transferred manually by the pharmacist onto the boxes of medication.

In one embodiment, the software application 22 provides the pharmacist with a standard dosage regimen according to a recommendation of the laboratory manufacturing the medication, the pharmacist being able to validate this dosage regimen or adjust it for a given patient depending on the medical prescription.

In the embodiment described here, the software application 22 then generates a bar code 31 encoding these items of information for taking medication and prints out this bar code 31 on the prescription 30.

As an example, the bar code 31 is used to encode an alphanumeric sequence, for example in the following form:
#OS#Medication:100609:150609:10:14:18

In this alphanumeric sequence:
“OS” is a prefix making it possible to verify the validity of the bar code;
“Medication” is the name of the medication, with or without the dosage regimen, with or without indications on the method of absorbing the medication;
“100609” is the date on which the treatment beings;
“150609” is the date on which the treatment ends; and
“10”, “14” and “18” are the times for taking the medication.

Any other method of encoding the information for taking the medication in the form of an alphanumeric sequence can also be envisaged.

As a variant, the bar code may contain additional information, for example, side effects capable of occurring when the medication is taken.

FIG. 2 represents an item of electronic equipment 10 according to an embodiment of the invention, namely, in this example, a cell phone.

In the exemplary embodiment described here, the cell phone 10 has the hardware architecture of a computer. It comprises notably a processor 11, a read-only memory of the ROM type 12, and a random access memory of the RAM type 13.

The read-only memory 12 of the ROM type constitutes a recording medium according to the invention. This recording medium comprises a computer program PG, this program comprising instructions for executing a configuration method according to the invention and the main steps of which are shown in FIG. 3.

The read-only memory 12 of the ROM type stores an electronic organizer AE application the data of which are stored in the data structure stored in a memory of the flash type 14. In a known manner, such data comprise data defining the appointments and/or reminders and/or tasks programmed into the organizer. These data comprise notably:
date and time of the appointment, of the reminder or of the task;
function(s) to be executed at the time of the reminder or of the task;
a possible frequency of the appointment, the reminder or the task;
a message that may be associated with the appointment, the reminder or the task;

etc.

Such data can be modified either from the organizer itself or from a software module associated with this organizer and loaded when this organizer is run, either from an independent software module capable of reading the data structure of the flash memory 14, capable of decoding and then interpreting these data, capable of encoding the modified data in the format used for them to be stored and then capable of storing the data thus encoded in the data structure of the flash memory 14.

The instructions of the computer program PG and those of the electronic organizer AE application can be executed by the processor 11, the variables necessary for the execution of these programs being stored in the random access memory 13.

The program PG is capable of interfacing with the electronic organizer application or is incorporated into such an electronic organizer application or shares with this application access to the data of the electronic organizer. The program PG is installed on the cell phone 10 by downloading from a website or according to any other appropriate method of installation.

Irrespective of the achievement method chosen for the program PG, this program is capable of configuring the electronic organizer AE application, that is to say of recording configuration data in the data structure of the flash memory 14.

The cell phone 10 also comprises a camera 15 with sufficient resolution to acquire a digital photograph of the bar code 31 making it possible to analyze the digital data of the photograph generated by the camera 15 in order to extract therefrom the items of information for taking medication that are encoded in this bar code 31.

The program PG and/or related hardware constitutes means capable of obtaining the digital data resulting from the digitization of the bar code 31, that is to say the digital photograph of the bar code 31.

In the exemplary embodiment described here, the configuration method according to embodiments of the invention optionally comprises a step E10 of presenting a test pattern to make it easier to position the bar code 31 relative to the mobile terminal 10.

The step E10 is followed by a step E20 for digitizing the printed bar code 31, this step being initiated by the user.

The step E20 is followed by a step E30 for obtaining the items of information for taking medication encoded in the bar code 31.

This step 30 consists in analyzing the digital data resulting from the digitization of the bar code 31 (in this instance the digital photograph) in order to extract therefrom the alphanumeric sequence represented by this bar code 31, and then in interpreting this alphanumeric sequence in order to extract therefrom the items of information for taking medication, that is to say the items of date information and the content associated with these items of date information as means for obtaining date information with content.

The step E30 is followed by a step E40 for configuring the electronic organizer AE application with the information for taking medication, this step consisting in recording, in the data structure of the flash memory 14, the information for taking medication, notably the content and the date information.

This manner of proceeding prevents the development of an additional application of the electronic organizer type for consulting and editing the information encoded in the representation of the code. Specifically, one and the same electronic organizer application makes it possible to display, consult and edit the programmed function and/or the associated content and/or the information encoded in the representation of the code (in the bar code) and to display, consult and edit other appointments/reminders/tasks programmed by the user by means of this electronic organizer. When this electronic organizer is used in a terminal with weak memory resources, this constitutes a precious economy in the available resources.

The step E40 also comprises configuration operations in order to program, on at least one date or at at least one time defined by the date information, an execution, based on the electronic organizer, of a function relating to the content.

As noted above, and described in more detail here, the system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Conventional software programming tools including compilers, linkers, or script/batch languages and the like, may be utilized for the programming. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

1. A method for configuring an electronic organizer installed in an item of electronic equipment, this method comprising the steps of:
obtaining, based on digital data resulting from a digitization of a representation of a code, data encoded in said code and comprising at least one item of date information associated with a content; and
configuring said electronic organizer in order to program, on at least one date or at least one time defined by said at least one item of date information, an execution of a function relating to said content.

2. The configuration method as claimed in claim 1, wherein the configuration step comprises a step of recording said at least one item of date information and said content in a data structure used by the electronic organizer.

3. The configuration method as claimed in claim 1, comprising a step of displaying a diary presenting for said date/time information items related to said function.

4. The configuration method as claimed in claim 1, comprising a step of displaying a diary presenting for said date/time information items related to said content.

5. The configuration method as claimed in claim 1, wherein said content comprises items of information relating to taking a medication, said function being a triggering of a reminder for said taking of medication.

6. The configuration method as claimed in claim 1, wherein said representation is a bar code.

7. An item of electronic equipment comprising:
an electronic organizer; and
means for obtaining data resulting from a digitization of a representation of a code;
said item of equipment comprising means for:
obtaining, from said data, at least one item of date information associated with a content; and
programming in said electronic organizer an execution of a function relating to said content on at least one date or at at least one time defined by said at least one item of date information.

8. The item of electronic equipment as claimed in claim 7, comprising a sensor that digitizes said representation.

9. The item of electronic equipment as claimed in claim 7, wherein said representation is a bar code.

10. The item of electronic equipment as claimed in claim 7, comprising a recorder for recording said at least one item of date information and said content into a data structure used by the electronic organizer.

11. The item of electronic equipment as claimed in claim 7, comprising a display for displaying a diary presenting for said date/time information items related to said function.

12. A computer-readable non-transitory recording medium on which a computer program is recorded comprising instructions for the execution of the steps of the configuration method as claimed in claim 1.
